(19) United States
(12) Patent Application Publication
(10) Pub. No.: US 2010/0027057 A1
(43) Pub. Date: Feb. 4, 2010

(54) CONTROL APPARATUS FOR CONTROLLING WORKFLOW INCLUDING A PLURALITY OF ACTIVITIES AND WORKFLOW CONTROL METHOD

(75) Inventor: Kunimasa Fujisawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/496,534

(22) Filed: Jul. 1, 2009

(30) Foreign Application Priority Data
Jul. 4, 2008 (JP) 2008-176218

(51) Int. Cl. G06F 3/12

(52) U.S. Cl. 358/1.15

(57) ABSTRACT

A method for controlling a workflow of a control apparatus configured to control a workflow including a plurality of activities includes determining a process included in an activity to be executed. If the activity to be executed includes a scan process of a document and an upload process of scan data generated by the scan process, the method further includes storing upload destination data so that a scanning apparatus connected to the control apparatus via a network uploads the scan data to an upload destination that is determined corresponding to the upload process.

### BACKGROUND OF THE INVENTION

1. Field of the Invention

The present invention relates to a control apparatus configured to control a workflow including a plurality of activities and a workflow control method.

2. Description of the Related Art

Nowadays, corporations have been introducing workflow systems as a tool for carrying out and managing business operations. Further, some companies that introduced purchase order management workflow systems scan contracts by digital multifunction peripherals (MFPs) and manually register the obtained results in the workflow systems as evidenced documents.

On the other hand, for example, Japanese Patent Application Laid-Open No. 2000-270148 describes a technique for acquiring a job template from a server, performing scanning, and registering a scanning result in the server that is described in the job template. A reading condition and a registration destination of a scanned document are set in the job template.

According to the conventional workflow systems, in adding data obtained by scanning a paper document to a workflow, it has been necessary to scan the paper document and associate the generated data with the workflow. When a number of workflows or process instances which the generated data is associated with and a number of pieces of scan data are increased, a quantity of work is also increased to an enormous amount. This may cause an error, for example, wrong scan data may be associated with a workflow or a process instance.

### SUMMARY OF THE INVENTION

The present invention is directed to preventing scan data from being uploaded to a wrong upload destination.

According to an aspect of the present invention, a method for controlling a workflow of a control apparatus configured to control a workflow including a plurality of activities includes determining a process included in an activity to be executed. If the activity to be executed includes a scan process of a document and an upload process of scan data generated by the scan process, the method further includes storing upload destination data so that a scanning apparatus connected to the control apparatus via a network uploads the scan data to an upload destination that is determined corresponding to the upload process.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a configuration of a workflow system according to an exemplary embodiment of the present invention.

FIGS. 2A and 2B are schematic diagrams illustrating a process and an activity that defines a workflow.

FIG. 3 is a schematic diagram of a process instance.

FIG. 4 illustrates an example of a process that defines the workflow executed by the workflow system and a detailed configuration of a scan/upload activity included in the process.

FIG. 5 is a block diagram illustrating a configuration of a workflow server according to an exemplary embodiment of the present invention.

FIG. 6 is a flowchart illustrating processing of a workflow server according to a first exemplary embodiment of the present invention.

FIG. 7 is a flowchart illustrating processing of an MFP according to the first exemplary embodiment of the present invention.

FIG. 8 is a flowchart illustrating processing of a workflow server according to a second exemplary embodiment of the present invention.

FIG. 9 is a sequence chart illustrating a process flow between the workflow server and the MFP according to the second exemplary embodiment of the present invention.

FIG. 10 is a business process modeling notation (BPMN) diagram of an application workflow system concerning settlement of travel expenses according to a third exemplary embodiment of the present invention.

FIG. 11 is a business process execution language (BPEL) code of the application workflow system concerning settlement of travel expenses according to the third exemplary embodiment of the present invention.

### DETAILED DESCRIPTION OF THE EMBODIMENTS

Various exemplary embodiments, features, and aspects of the invention will be described in detail below with reference to the drawings.

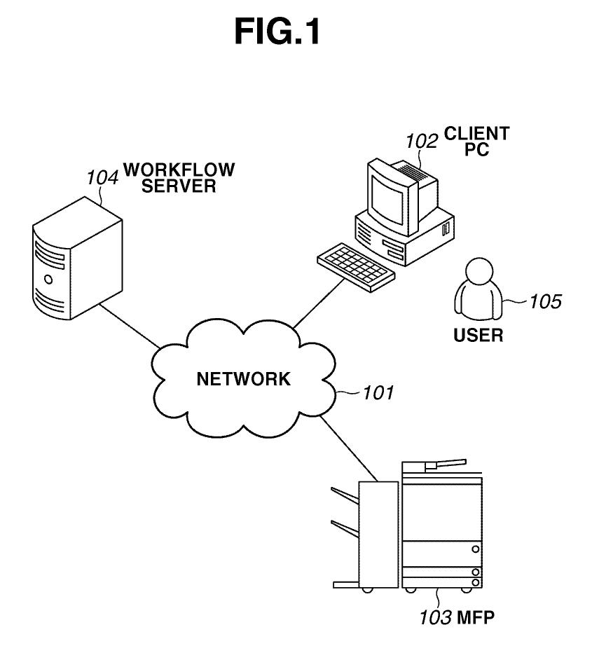

FIG. 1 illustrates a configuration of a workflow system according to a first exemplary embodiment of the present invention. In FIG. 1, a user 105 performs an operation concerning the workflow using a client personal computer (PC) 102. A digital MFP 103 scans a paper document. A workflow server 104 is an information processing apparatus. The workflow server 104, the MFP 103, and the client PC 102 are connected via a network 110. According to the present exemplary embodiment, the MFP 103 is used as a scanning apparatus.

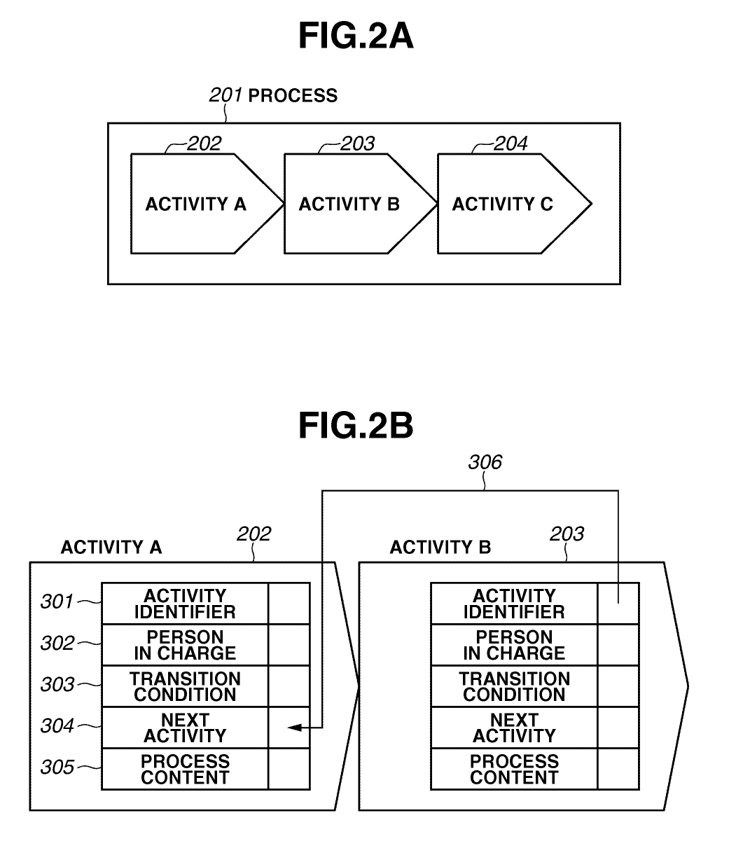

FIG. 2A is a schematic diagram illustrating a process for defining the workflow. The workflow executed by the workflow system according to the present exemplary embodiment is defined by a process 201 illustrated in FIG. 2A. The process 201 defines a process to be performed and includes activities 202, 203, and 204 which define each of the processes that configure the process 201. Further, the process 201 defines an execution order of each of the activities 202, 203, and 204. Information that defines the process 201 is registered in the workflow server 104 in advance.

FIG. 2B is a schematic diagram of an activity. In FIG. 2B, the activities 202 and 203 are illustrated but the activity 204 is omitted. Each of the activities 202, 203, and 204 that configure the process 201 includes an activity identifier 301, a person in charge 302, a transition condition 303, a next activity 304, and a process content 305. The activity identifier 301 is an identifier for identifying an activity. The person in charge 302 is a person who executes the activity. The transition condition 303 is a condition for transition to the next activity. The process content 305 is content of a process carried out by the activity.

An activity identifier of the next activity is described in the next activity 304. As is indicated by an arrow 306 in FIG. 2B, an activity is associated with a next activity to be executed.

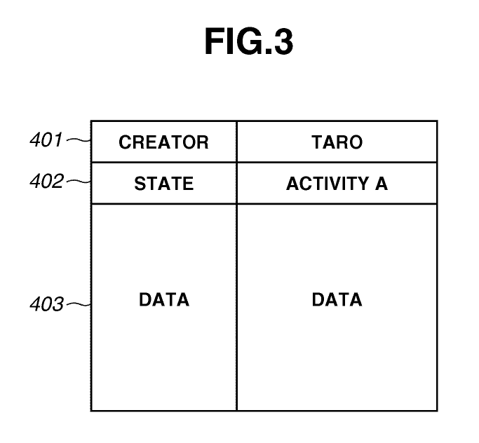

FIG. 3 is a schematic diagram of a process instance. When the user 105 starts the workflow process by operating the client PC 102, the process instance illustrated in FIG. 3 is generated by the workflow server 104. Data of a process of each user is stored in the process instance. The process instance includes a creator 401, a state 402, and data 403. The creator 401 is a name of a creator (user who started the workflow) of the process instance. The state 402 indicates an activity that is currently being executed by the workflow server 104. The data 403 is data which is input in each activity.

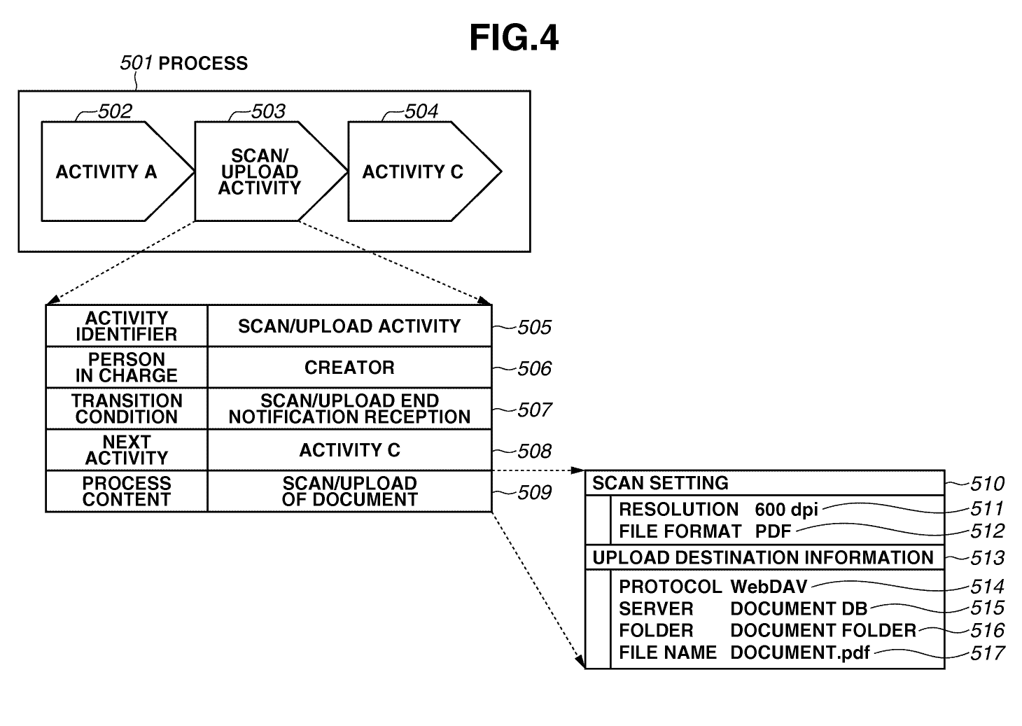

FIG. 4 illustrates an example of a process 501 that defines the workflow executed by the workflow system and a detailed configuration of a scan/upload activity 503 included in the process 501 according to the present exemplary embodiment. The scan/upload activity 503 is an example of a document reading activity.

The process 501 includes an activity A 502 and an activity C 504 which are activities for carrying out a general process, and the scan/upload activity 503 which is an activity for scanning a document and uploading a scanning result to a document server. The process 501 is started from the activity A 502 according to a request that is sent from the client PC 102.

A “scan/upload activity” 505 is defined as an activity identifier in the scan/upload activity 503. Additionally, a “creator” 506 is defined as a person in charge and a “scan/upload end notification reception” 507 is defined as a condition for transition to the next activity in the scan/upload activity 503.

Further, an “activity C” 508 is defined as a next activity and a “scan/upload of document” 509 is defined as the process content in the scan/upload activity 503. Furthermore, a scan setting 510 and upload destination information 513 are defined in the process content of the “scan/upload of document” 509. The upload destination information 513 is information about an upload destination and the scan setting 510 is information about scan setting. Although the activity identifier, the person in charge, the transition condition, and the process content carried out by the activity are described in natural language according to the present exemplary embodiment, such information can be represented, for example, by an ID number.

Settings necessary for scanning are defined by the scan setting 510. Such settings are, for example, resolution 511 used when the paper document is scanned and a file format 512 of data obtained by the scanning.

The upload destination information 513 defines upload protocol information 514, a server name 515 of an upload destination server for storing data, a folder name 516 of a folder for storing the data in the upload destination server, and a file name 517 of the data to be stored. The upload protocol information 514 is used for designating a network protocol that is used when the scanning result is uploaded to the document server among network protocols supported by the MFP 103. For example, a network protocol name such as “web-based distributed authoring and versioning (WebDAV)”, “hypertext transfer protocol (HTTP)”, or “server message block (SMB)” is described in the upload protocol information 514.

The scan setting 510 and the upload destination information 513 are defined by the scan/upload activity 503. Thus, even if the process 501 includes a plurality of scan/upload activities, the scan setting 510 and the upload destination information 513 can be defined for each scan/upload activity.

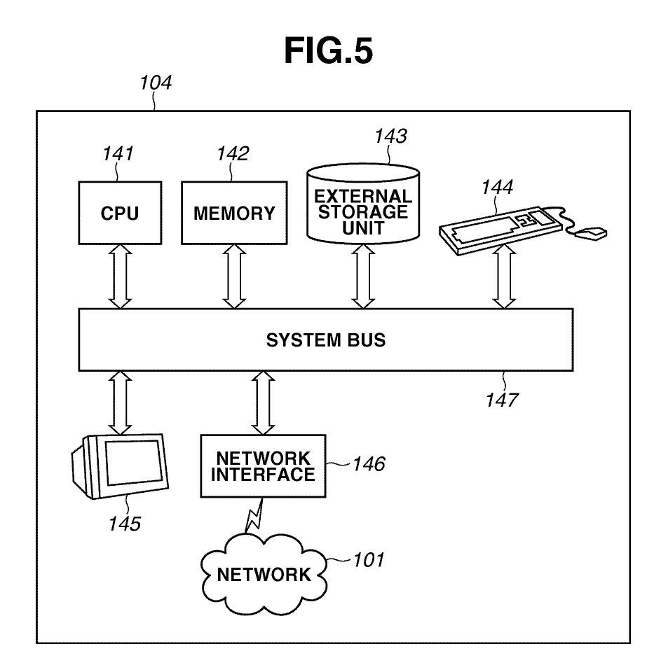

FIG. 5 is a block diagram illustrating a configuration of the workflow server 104 according to the exemplary embodiment of the present invention.

The workflow server 104 includes a central processing unit (CPU) 141 that controls the entire workflow server 104 and a memory 142 that temporarily stores a program or data supplied from an external storage unit 143. The process instance illustrated in FIG. 3 and the process 501 illustrated in FIG. 4 are also stored in the memory 142. The workflow server 104 further includes the external storage unit 143 such as a hard disk or a memory card, an input device 144 such as a pointing device or a keyboard, a display monitor 145, and a network interface 146 via which the workflow server 104 is connected to the network 101. The CPU 141, the memory 142, the external storage unit 143, the input device 144, the display monitor 145, and the network interface 146 are connected to a system bus 147 for communication.

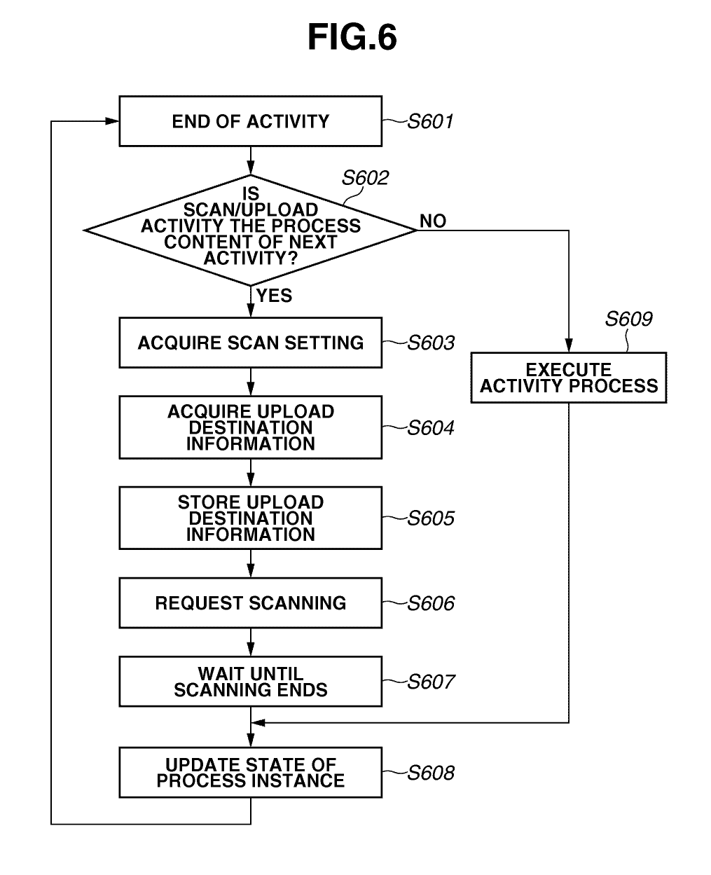

Next, the processing of the workflow server 104 according to the first exemplary embodiment of the present invention will be described referring to the flowchart illustrated in FIG. 6.

In step S601, when one activity that constitutes the process 501 in the MFP 103 ends, in step S602, the workflow server 104 determines whether the process content of the next activity relates to scanning/uploading a document. At the beginning of the process, the workflow server 104 determines whether the process content of the first activity relates to scanning/uploading a document. If the process content of the next activity is determined not to relate to scanning/uploading a document (NO in step S602), then the process proceeds to step S609. In step S609, the workflow server 104 performs the process content defined in the next activity. Next, in step S608, the workflow server 104 changes the state 402 of the process instance to the next activity. In this way, the activity to be executed is transferred to the next activity.

On the other hand, if the process content of the next activity is determined to relate to scanning/uploading a document (YES in step S602), then the process proceeds to step S603. In step S603, the workflow server 104 acquires the scan setting 510 from the process content defined in the next activity. Similarly, in step S604, the workflow server 104 acquires the upload destination information 513 from the process content defined in the next activity. The process 501 that includes the “scan/upload of document” 509 is stored in the memory 142. Next, in step S605, the workflow server 104 stores the upload destination information 513 in the data 403 of the process instance.

In step S606, the workflow server 104 transmits the scan setting 510 and the upload destination information 513 to the MFP 103, and requests the MFP 103 to start the scan/upload process after making the scan setting 510 and setting the upload destination information 513 in the MFP 103. In step S607, the workflow server 104 temporarily stops the processing until it receives an end notification of the scan/upload process from the MFP 103.

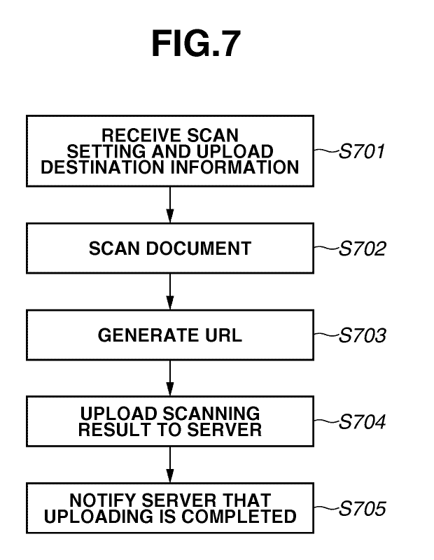

FIG. 7 is a flowchart illustrating processing of the MFP 103 according to the first exemplary embodiment of the present invention. A process flow of the workflow system according to the present exemplary embodiment will be described below referring to the flowchart illustrated in FIG. 7. The configuration of the MFP 103 is similar to the configuration illustrated in FIG. 5 except that a scanner is connected to the system bus 147.

In step S701, the MFP 103 receives the scan setting 510 and the upload destination information 513 from the workflow server 104. In step S702, the MFP 103 scans a document based on the settings of the resolution 511 of “600 dpi” and the file format 512 of a “portable document format (PDF)” according to the scan setting 510.

Additionally, according to the upload destination information 513 sent from the workflow server 104, the MFP 103 uploads the data of the scanning result. For example, as illustrated in FIG. 4, if a protocol described in the upload destination information 513 is “WebDAV”, the MFP 103 uploads the scanning result using the WebDAV protocol. In step S703, the MFP 103 generates a uniform resource locator (URL) which is address information (upload destination designation information), “http://document DB/document folder/document.pdf”, based on the server name 515, the folder name 516, and the file name 517. In step S704, the MFP 103 uploads the scanning result to the URL using the WebDAV protocol and the scanning result is stored in a server (document DB) (not shown).

In step S705, when the uploading of the scanning result is completed, the MFP 103 notifies the workflow server 104 that the scan/upload process is completed.

When the workflow server 104 receives an end notification of uploading of the scanning result from the MFP 103, the process proceeds from step S607 to step S608. In step S608, the workflow server 104 changes the state 402 of the process instance to the activity defined in the next activity 304. Then, the process returns to step S601, the workflow server 104 terminates the currently executed process, and the process proceeds to the next activity.

According to the present exemplary embodiment, the upload destination information 513 is stored in the data 403 of the process instance in step S605. Thus, data of the scanning result can be referred to in a different activity by using the upload destination information 513 that is stored in the data 403 of the process instance.

A second exemplary embodiment of the present invention will be described. The processes and the activities of the present exemplary embodiment are similar to those of the first exemplary embodiment. Further, the configuration of the workflow system of the present exemplary embodiment is similar to that of the first exemplary embodiment illustrated in FIG. 1.

According to the present exemplary embodiment, the scan setting 510, the upload protocol information 514, and the server name 515 of the upload destination which are defined in a scan/upload activity that corresponds to the scan/upload activity 503 according to the first exemplary embodiment, are the same as those illustrated in FIG. 4. Further, according to the present exemplary embodiment, unlike what is illustrated in FIG. 4, a “[creator] folder” is set as a template of the folder name 516 of the folder for storing the data in the upload destination server. Further, “document [creator].pdf” is set as a template of the file name 517 of the data to be stored. The template of the folder name and the template of the file name according to the present exemplary embodiment can generate upload destination information when a value of the creator 401 that corresponds to the process instance is entered in a “[value name]” included in the template.

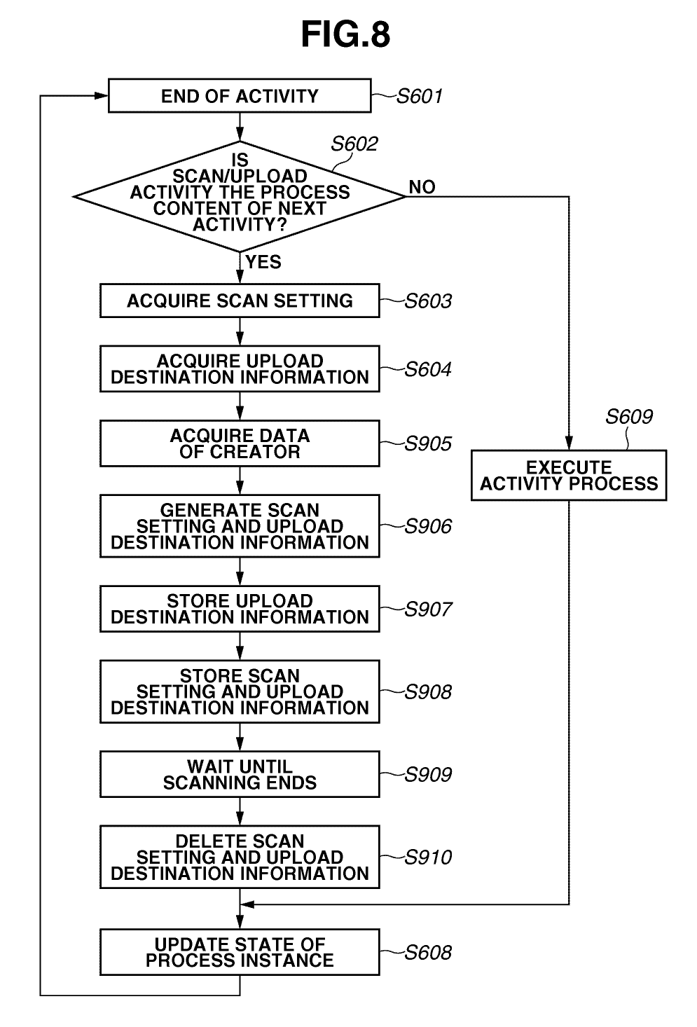

When the user 105 starts the workflow process using the client PC 102, the workflow server 104 generates a process instance similar to that of the first exemplary embodiment which is illustrated in FIG. 3. The processing of the workflow server 104 according to the second exemplary embodiment of the present invention will be described referring to the flowchart illustrated in FIG. 8. In FIG. 8, steps S601 to S604, S608, and S609 are the same as the steps denoted by the same step number in FIG. 6.

In step S905, after executing steps S603 and S604, the workflow server 104 acquires data of the creator 401 from the process instance that is being processed. In step S906, the workflow server 104 substitutes the “[creator]” included in the upload destination information acquired in step S604 with the data of the creator 401 acquired in step S905, and generates upload destination information. For example, in a case of the process instance illustrated in FIG. 3, “Taro”, a value of the creator 401, of the process instance is merged, and the folder name is changed to “Taro folder”. Further, the file name is changed to “document Taro.pdf”. Since the value of the creator 401 is user identification information, ID information which can identify a creator can be used as well as a name of the creator.

In step S907, the workflow server 104 stores the upload destination information generated in step S906 in the data 403 of the process instance.

In step S908, the workflow server 104 stores the scan setting 510 and the upload destination information generated in step S906 in a scan/upload setting storage area of the creator of the process instance. The scan/upload setting storage area is used for temporarily storing the upload destination information generated in step S906 for each creator of the process instance. The scan/upload setting storage area can be accessed from both the workflow server 104 and the MFP 103. For example, the scan/upload setting storage area is a home folder of a creator of a process instance stored in a file server (not shown) connected to the network 101. The scan/upload setting storage area can be in the workflow server 104 or the MFP 103.

In step S909, the workflow server 104 temporarily stops the processing until it receives an end notification of the scan/upload process from the MFP 103.

According to the present exemplary embodiment, the scan setting and the upload destination information are stored in the scan/upload setting storage area. The MFP 103 acquires the scan setting and the upload destination information from the scan/upload setting storage area during scanning. As another exemplary embodiment, the workflow server 104 can directly transmit the scan setting and the upload destination information to the MFP 103 and request scanning.

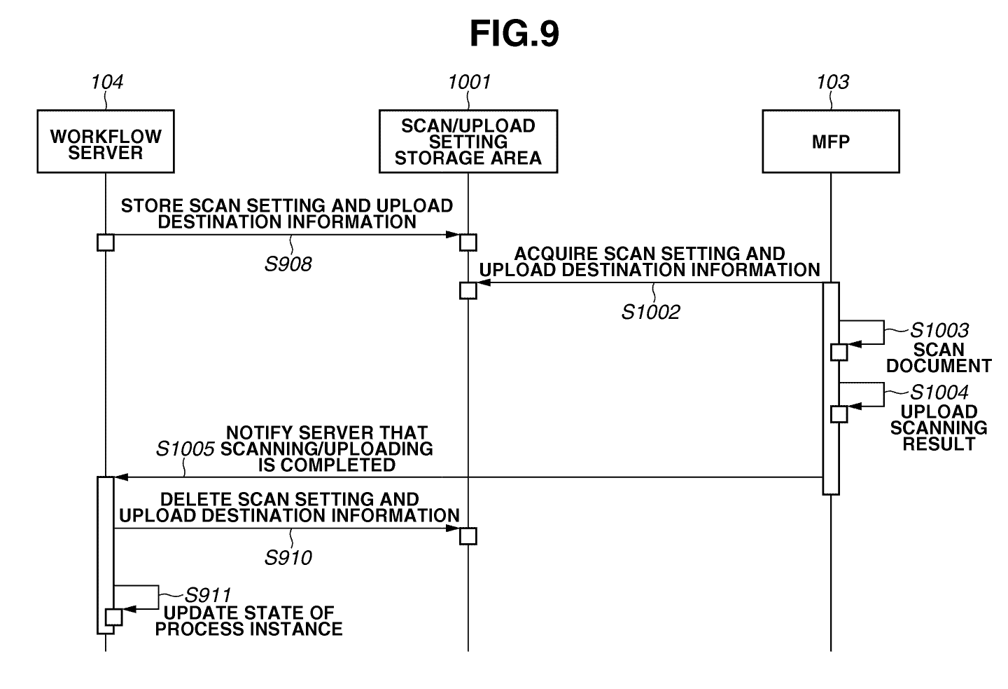

FIG. 9 is a sequence chart illustrating a process flow between the workflow server 104 and the MFP 103. The process flow of the workflow system according to the present embodiment will be described referring to the sequence chart illustrated in FIG. 9.

In step S1002, if the user requests a start of the scan process using the MFP 103, the MFP 103 acquires the scan setting and the upload destination information stored in a scan/upload setting storage area 1001. In step S1003, the MFP 103 scans a document according to the scan setting as performed in the first exemplary embodiment. In step S1004, the MFP 103 uploads the scanning result to the upload destination according to the upload destination information. In step S1005, the MFP 103 notifies the workflow server 104 that the scanning/uploading is completed, and ends the scan process.

When the workflow server 104 receives the notification of uploading the scanning result, the process in step S909 in FIG. 8 ends. In step S910, the workflow server 104 deletes the scan setting and the upload destination information acquired and stored in step S1002 from the scan/upload setting storage area 1001.

In step S911, the workflow server 104 changes the state 402 of the process instance to the activity defined in the next activity 304. In step S601, the workflow server 104 terminates the currently executed process, and the process proceeds to the next activity.

According to the present exemplary embodiment, the upload destination information is stored in a portion of the data 403 of the process instance in step S907. Thus, the data of the scanning result can be referred to in a different activity by using the upload destination information stored in the data 403 of the process instance.

According to the above-described exemplary embodiments, in addition to setting the scan setting defined by the process in the MFP 103, a URL that indicates the upload destination is generated by using the upload destination information defined by the process and the generated URL is set in the MFP 103. Thus, uploading of scan data based on wrong setting and uploading of scan data to a wrong upload destination due to an operation error of the user can be prevented.

Further, according to the above-described exemplary embodiments, the upload destination of the scan data is stored in a process instance that corresponds to the scan/upload activity. Thus, an operation for associating the scan data with the process instance is unnecessary, so that an association error can be prevented.

A third exemplary embodiment of the present invention will be described referring to an example of a virtual workflow of settlement of travel expenses. The workflow of settlement of travel expenses according to the present exemplary embodiment is simplified for description of the present exemplary embodiment.

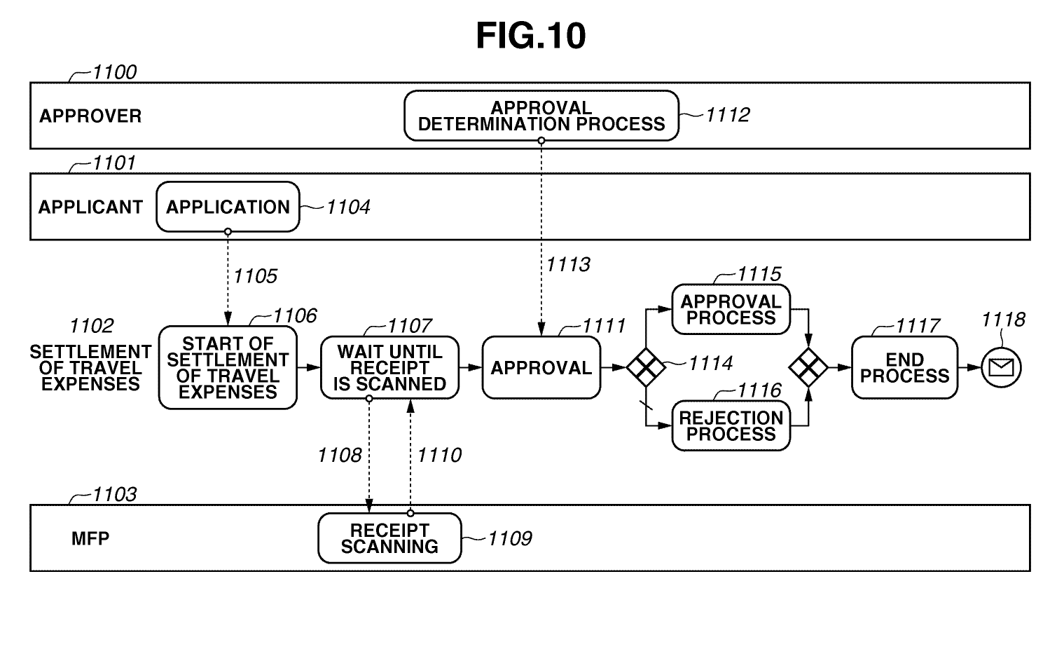

FIG. 10 is a BPMN diagram of the workflow of settlement of travel expenses according to the present invention. The BPMN diagram is based on a business modeling notation which is defined by Business Process Modeling Initiative (BPMI).

In FIG. 10, a swimlane 1100 represents an approver. A swimlane 1101 represents an applicant. A swimlane 1102 represents a workflow system for settlement of travel expenses in the workflow server 104. A swimlane 1103 is for a MFP that performs scanning.

An application process task 1104 is performed by the applicant. An application message 1105 includes information about a business trip date, a business trip destination, transportation expenses, and an accommodation fee that are necessary in the application. A start-of-settlement-of-travel-expenses task 1106 represents a start of the settlement process of travel expenses.

A wait-until-receipt-is-scanned task 1107 requests the swimlane 1103 of the MFP to perform scanning of a receipt and waits until the receipt is scanned. A scan request message 1108 includes scan setting and a storage destination of the scanned data that are sent to the swimlane 1103 of the MFP. A receipt scanning task 1109 scans the receipt in the swimlane 1103 of the MFP according to the information in the scan request message 1108. According to a scan completion message 1110, the workflow system for settlement of travel expenses is notified that the scanning of the receipt in the swimlane 1103 of the MFP has been completed.

An approval task 1111 represents a status waiting for approval by the approver. An approval determination process task 1112 is performed by the approver. An approval/rejection message 1113 includes information about the approval/rejection by the approver. A gateway 1114 sorts the approval/rejection. An approval process task 1115 is executed when the application is approved. A rejection process task 1116 is executed when the application is rejected. An end process task 1117 performs an end process of the application. An end event 1118 indicates that the process of the settlement of travel expenses is completed.

The application process task 1104 and the approval determination process 1112 can be executed by different PCs or by the same client PC 102. The receipt scanning task 1109 is executed by the MFP 103.

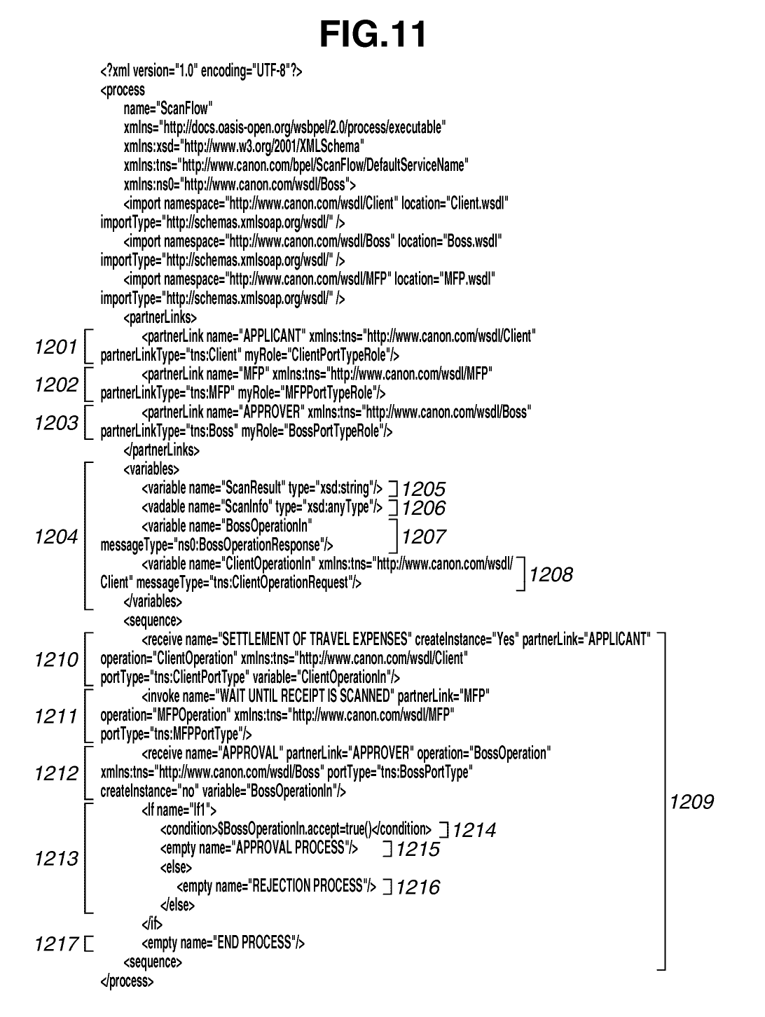

FIG. 11 is the workflow system for settlement of travel expenses, which is described using a pseudo BPEL code. This workflow system is expressed in the BPMN diagram in FIG. 10.

A partner link 1201 of the applicant corresponds to the swimlane 1101 of the applicant. A partner link 1202 of the MFP corresponds to the swimlane 1103 of the MFP. A partner link 1203 of the approver corresponds to the swimlane 1100 of the approver.

A declaration portion 1204 of the message declares following four messages. A message 1205 for returning the scanning result corresponds to the scan completion message 1110. A message 1206 that includes the scan setting and the storage destination of the scanned data corresponds to the scan request message 1108. An approval message 1207 that is sent from the approver corresponds to the approval/rejection message 1113. A message 1208 that includes a business trip date, a business trip destination, transportation expenses, and an accommodation fee sent from the applicant corresponds to the application message 1105.

A definition portion 1209 of the processing of the workflow of settlement of travel expenses includes an activity 1210 concerning settlement of travel expenses, an activity 1211 concerning waiting until receipt is scanned, an approval activity 1212, a branch activity 1213 for sorting processes according to an approval content, and an end process activity 1217. Since the definition portion 1209 is a sequence element, the activities included in the definition portion 1209 are serially executed according to the order of the description.

The activity 1210 concerning settlement of travel expenses corresponds to the start-of-settlement-of-travel-expenses task 1106. Since the activity 1210 concerning settlement of travel expenses is an activity regarding an receive element, the activity 1210 waits until a message is sent from an applicant partner link indicated by a partnerLink attribute. When the activity 1210 receives the message, the process proceeds to the next activity.

The activity 1211 concerning waiting until receipt is scanned corresponds to the wait-until-receipt-is-scanned task 1107. Since the activity 1211 is an activity regarding an invoke element, the activity 1211 sends a message to an MFP partner link indicated by the partnerLink attribute. When the activity 1211 receives a reply, the process proceeds to the next activity.

The approval activity 1212 corresponds to the approval task 1111 which represents the status waiting for approval by the approver. Since the approval activity 1212 is an activity regarding a receive element, the activity 1210 waits until a message is sent from an approver partner link indicated by the partnerLink attribute. When the approval activity 1212 receives the message, the process proceeds to the next activity.

The branch activity 1213 includes a branch condition 1214, an approval process activity 1215, and a rejection process activity 1216. A branch condition is described in the branch condition 1214. Whether the approval message 1207 sent from the approver partner link is true is determined by the branch condition 1214. The branch condition 1214 corresponds to the gateway 1114. The approval process activity 1215 is executed when the application for settlement of travel expenses is approved by the approver. According to the present exemplary embodiment, since detailed description of the approval process is not necessary, it is described using an empty element. The approval process activity 1215 corresponds to the approval process task 1115.

The rejection process activity 1216 is executed when the application for settlement of travel expenses is rejected by the approver. According to the present exemplary embodiment, since detailed description of the rejection process is not necessary, it is described using an empty element. The rejection process activity 1216 corresponds to the rejection process task 1116.

The end process activity 1217 is executed after the approval process or the rejection process is executed. According to the present exemplary embodiment, since detailed description of the end process is not necessary, it is described using an empty element. The end process activity 1217 corresponds to the end process task 1117.

Next, a process flow of the workflow of the present exemplary embodiment will be described referring to the BPMN diagram illustrated in FIG. 10.

First, the applicant of the swimlane 1101 executes the application process task 1104 for settlement of the travel expenses using the client PC 102. Then, the application message 1105 including information about the business trip date, business trip destination, transportation expenses, and accommodation fee is sent to the start-of-settlement-of-travel-expenses task 1106 of the workflow system for settlement of travel expenses of the swimlane 1102 in the workflow server 104. The start-of-settlement-of-travel-expenses task 1106 acquires the business trip date, business trip destination, transportation expenses, and accommodation fee from the received application message 1105 and stores the data. Then the process proceeds to the wait-until-receipt-is-scanned task 1107.

The start-of-settlement-of-travel-expenses task 1106 corresponds to the activity A 502 in FIG. 4. The wait-until-receipt-is-scanned task 1107 corresponds to the scan/upload activity 503 in FIG. 4. As is in step S602 in FIG. 6, the workflow system for settlement of travel expenses of the swimlane 1102 determines that the next activity is the wait-until-receipt-is-scanned task 1107 when the start-of-settlement-of-travel-expenses task 1106 is completed.

The wait-until-receipt-is-scanned task 1107 sends the scan request message 1108 to the swimlane 1103 of the MFP. This transmission of the scan request message 1108 corresponds to step S606 in FIG. 6. The scan setting of the scan request message 1108 is stored as setting of the workflow, and the wait-until-receipt-is-scanned task 1107 acquires the setting that is stored. This acquisition corresponds to step S603 in FIG. 6. Further, information about the storage destination of the scanned data is, for example, as illustrated in step S906 in FIG. 8, information that is generated based on applicant information.

When the receipt scanning task 1109 of the swimlane 1103 of the MFP 103 receives the scan request message 1108, the MFP 103 stores the scan setting and the storage destination which are included in the message, and waits until the user starts the scanning operation. When the user starts the scanning operation, the receipt is scanned according to the scan setting at the swimlane 1103 of the MFP and image data of the scanning result is stored in a file server or a database designated as a storage destination of the image data. Then, scanning is executed for the wait-until-receipt-is-scanned task 1107 and the scan completion message 1110 which indicates that the scanning is executed and the data is stored is sent. The process of the receipt scanning task 1109 of the MFP 103 can be similar to the process that is described in FIG. 7.

When the wait-until-receipt-is-scanned task 1107 of the workflow server 104 receives the scan completion message 1110, the approval task 1111 is started. The approval task 1111 waits until the approver of the swimlane 1100 executes the approval determination process task 1112 and sends the approval/rejection message 1113.

The reception of the scan completion message 1110 corresponds to the scan/upload end notification reception 507 in FIG. 4. The wait-until-receipt-is-scanned task 1107 corresponds to the scan/upload activity 503 in FIG. 4, and the approval task 1111 corresponds to the activity C 504. When the workflow system for settlement of travel expenses of the swimlane 1102 receives the scan completion message 1110, the process proceeds from the wait-until-receipt-is-scanned task 1107 to the approval task 1111.

The approver of the swimlane 1100 confirms information about the business trip date, business trip destination, transportation expenses, and accommodation fee or the image data of the scanning result by using the client PC 102, determines whether to approve or reject the application, and executes the approval determination process task 1112. According to the present exemplary embodiment, in order to simplify the description, a method used by the approver for confirming the information about the business trip date, business trip destination, transportation expenses, and accommodation fee or the image data of the scanning result is not described. When the approval determination process task 1112 is executed, information about the approval/rejection is sent to the approval task 1111 as the approval/rejection message 1113.

When the approval task 1111 receives the approval/rejection message 1113, the process proceeds to the gateway 1114. Information about whether the application is approved or rejected is acquired from the approval/rejection message 1113 at the gateway 1114, and based on the branch condition 1214 described in the condition element in FIG. 11, the approval or rejection of the application is determined. If the application is approved, then the process proceeds to the approval process task 1115. If the application is rejected, then the process proceeds to the rejection process task 1116.

The approval process task 1115 executes a process such as a bank transfer of the travel expenses, and the process proceeds to the end process task 1117. The rejection process task 1116, for example, sends a rejection notification to the applicant of the swimlane 1101, and the process proceeds to the end process task 1117. At the end process task 1117, a process that is necessary for completing the application is performed, and then the end event 1118 is issued. In this way, the application for settlement of travel expenses is completed.

Each unit and step that configures the above-described exemplary embodiments of the present invention can be realized by executing a program stored in a random access memory (RAM) or a read-only memory (ROM) of a computer. The program and a computer readable recording medium that records the program are included in the present invention.

The above-described exemplary embodiments can be also realized by, for example, a system, an apparatus, a method, a program, or a storage medium. More specifically, the above-described exemplary embodiments can be applied to an apparatus including a single device.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2008-176218 filed Jul. 4, 2008, which is hereby incorporated by reference herein in its entirety.

What is claimed is:

1. A method for controlling a workflow of a control apparatus configured to control a workflow including a plurality of activities, the method comprising:
determining a process included in an activity to be executed, and
storing upload destination data, if the activity to be executed includes a scan process of a document and an upload process of scan data generated by the scan process, so that a scanning apparatus connected to the control apparatus via a network uploads the scan data to an upload destination that is determined corresponding to the upload process.

2. The method according to claim 1, wherein the upload destination data is stored in the scanning apparatus.

3. The method according to claim 1, wherein the upload destination data is stored in a server connected to the network so that the upload destination data is accessible from the scanning apparatus.

4. The method according to claim 1, wherein a condition for scanning the document is stored.

5. The method according to claim 1, wherein the scanning apparatus stores a name of the scan data to be uploaded to the upload destination.

6. The method according to claim 1, wherein the upload destination data is stored so that the scanning apparatus uploads the scan data to the upload destination corresponding to a user who started the workflow.

7. A control apparatus configured to control a workflow including a plurality of activities, the control apparatus comprising:
a determining unit configured to determine a process included in an activity to be executed, and
a storage unit configured to store upload destination data, if the activity to be executed includes a scan process of a document and an upload process of scan data generated by the scan process so that a scanning apparatus connected to the control apparatus via a network uploads the scan data to an upload destination that is determined corresponding to the upload process.

8. The control apparatus according to claim 7, wherein the storage unit stores the upload destination data in the scanning apparatus.

9. The control apparatus according to claim 7, wherein the storage unit stores the upload destination data in a server connected to the network so that the upload destination data is accessible from the scanning apparatus.

10. The control apparatus according to claim 7, wherein the storage unit stores a condition for scanning the document.

11. The control apparatus according to claim 7, wherein the storage unit stores a name of the scan data to be uploaded to the upload destination by the scanning apparatus.

12. The control apparatus according to claim 7, wherein the storage unit stores the upload destination data so that the scanning apparatus uploads the scan data to the upload destination corresponding to a user who started the workflow.

13. A storage medium storing a computer-executable program for controlling a workflow including a plurality of activities, the computer-executable program comprising:
determining a process included in an activity to be executed, and
storing upload destination data, if the activity to be executed includes a scan process of a document and an upload process of scan data generated by the scan process, so that a scanning apparatus connected to the control apparatus via a network uploads the scan data to an upload destination that is determined corresponding to the upload process.

14. The storage medium according to claim 13, wherein the computer-executable program stores the upload destination data in the scanning apparatus.

15. The storage medium according to claim 13, wherein the computer-executable program stores the upload destination data in a server connected to the network so that the upload destination data is accessible from the scanning apparatus.

16. The storage medium according to claim 13, wherein the computer-executable program stores a condition for scanning the document.

17. The storage medium according to claim 13, wherein the computer-executable program stores a name of the scan data to be uploaded to the upload destination.

18. The storage medium according to claim 13, wherein the computer-executable program stores the upload destination data so that the scanning apparatus uploads the scan data to the upload destination corresponding to a user who started the workflow.
